(19) United States
(12) Patent Application Publication
(10) Pub. No.: US 2024/0330095 A1
(43) Pub. Date: Oct. 3, 2024

(54) ELECTRONIC DEVICE DEBUG METHOD AND ELECTRONIC DEVICE DEBUG SYSTEM

(71) Applicant: Realtek Semiconductor Corp., HsinChu (TW)

(72) Inventor: Kai-Yuan Chang, HsinChu (TW)

(73) Assignee: Realtek Semiconductor Corp., HsinChu (TW)

(21) Appl. No.: 18/244,304

(22) Filed: Sep. 11, 2023

(30) Foreign Application Priority Data
Mar. 27, 2023 (TW) 112111449

(51) Int. Cl. G06F 11/07; G06F 11/14

(52) U.S. Cl. CPC G06F 11/0784; G06F 11/1441

(57) ABSTRACT

An electronic device debug method, applied to a target electronic device with an error detecting device, a debug device, and a transceiving device, comprising: (a) detecting an error of the target electronic device by the error detecting device to generate error information corresponding to the error; (b) transmitting the error information to the transceiving device through the debug device; (c) transmitting the error information to a remote electronic device through the transceiving device by a wireless network; and (d) controlling the target electronic device to perform a debug procedure corresponding to the error information by the remote electronic device, through the transceiving device.

### BACKGROUND OF THE INVENTION

### 1. Field of the Invention

The present invention relates to an electronic device debug method and an electronic device debug system, and particularly relates to an electronic device debug method and an electronic device debug system which can debug by a wireless method.

### 2. Description of the Prior Art

In the prior art, if an error occurs in an electronic device but the electronic device cannot debug by itself, an analysis device is always used to wired-connect with the electronic device through a connection interface for analysis and debug. For example, when an error occurs in a laptop computer and cannot debug by itself, another laptop computer can be connected to the laptop computer with an error through a USB interface for debug. However, if an error occurs in the connection interface, such mechanism cannot be used. In such case, the electronic device may be in an inoperable state due to the error, and it is difficult for the electronic device to be connected to the analysis device by other ways.

In addition, if the electronic device has been manufactured and is being used by the user, since the user usually does not understand the debug mechanism or does not have the corresponding equipment and software, it is impossible to debug the error through the above-mentioned method. Therefore, a new mechanism for debug electronic devices is needed.

### SUMMARY OF THE INVENTION

Accordingly, one objective of the present invention is to provide an electronic device debug method which can automatically detect an error and debug via a wireless method.

Another objective of the present invention is to provide an electronic device debug system which can automatically detect an error and debug via a wireless method.

One embodiment of the present invention discloses an electronic device debug method, applied to a target electronic device with an error detecting device, a debug device, and a transceiving device, comprising: (a) detecting an error of the target electronic device by the error detecting device to generate error information corresponding to the error; (b) transmitting the error information to the transceiving device through the debug device; (c) transmitting the error information to a remote electronic device through the transceiving device by a wireless network; and (d) controlling the target electronic device to perform a debug procedure corresponding to the error information by the remote electronic device, through the transceiving device.

Another embodiment of the present invention discloses an electronic debug system, comprising: an error detecting device, configured to detect an error of a target electronic device to generate error information corresponding to the error; a debug device, configured to receive the error information from the error detecting device; and a transceiving device, configured to receive the error information from the debug device, and configured to transmit the error information to a remote electronic device by a wireless network; wherein the remote electronic device controls the target electronic device to perform a debug procedure corresponding to the error information through the transceiving device.

In view of above-mentioned embodiments, even if the target electronic device has an error but cannot debug by itself, and the communication interface providing a wired connection is damaged, the error information can still be provided to other electronic devices in a wireless connection to debug the target electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an electronic device debug system according to one embodiment of the present invention.

FIG. 2 is a schematic diagram illustrating that a target electronic device communicates with a remote electronic device, according to different embodiments of the present invention.

FIG. 3 and FIG. 4 are schematic diagrams illustrating that the electronic debug system operates in different modes, according to different embodiments of the present invention.

FIG. 5 is a block diagram illustrating an electronic debug system according to another embodiment of the present invention.

FIG. 6 is a flow chart illustrating an electronic device debug method according to one embodiment of the present invention.

### DETAILED DESCRIPTION

Several embodiments are provided in following descriptions to explain the concept of the present invention. Each component in following descriptions can be implemented by hardware (e.g. a device or a circuit) or hardware with software (e.g. a program installed to a processor). Besides, the method in following descriptions can be executed by programs stored in a non-transitory computer readable recording medium such as a hard disk, an optical disc or a memory. Additionally, the term “first”, “second”, “third” in following descriptions are only for the purpose of distinguishing different one elements, and do not mean the sequence of the elements. For example, a first device and a second device only mean these devices can have the same structure but are different devices.

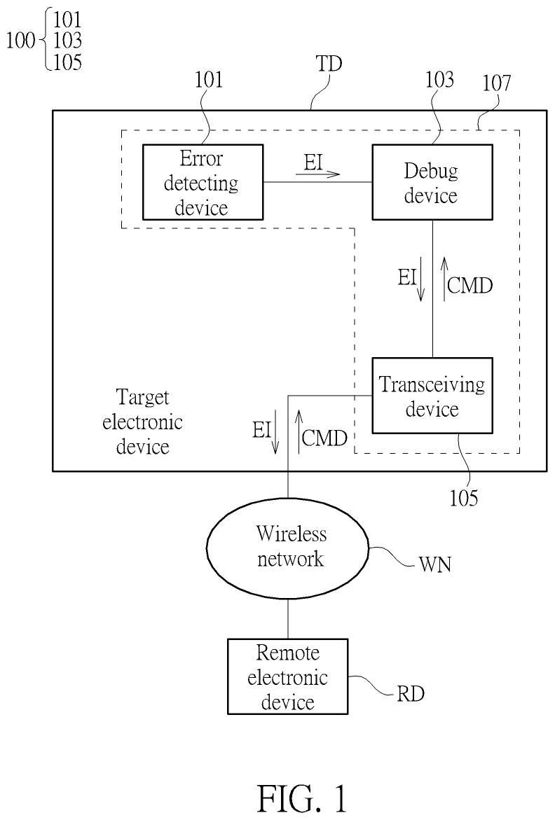

FIG. 1 is a block diagram illustrating an electronic device debug system 100 according to one embodiment of the present invention. As shown in FIG. 1, the electronic device debug system 100 is provided in a target electronic device TD, and comprises an error detecting device 101, a debug device 103 and a transceiving device 105. The error detecting device 101 is configured to detect errors in the target electronic device TD to generate corresponding error information EI, and to transmit the error information EI to the transceiving device 105. The debug device 103 transmits the error information EI to the transceiving device 105. The transceiving device 105 converts the error information EI into a transmittable format of the wireless network WN, and transmits the error information EI to the remote electronic device RD through the wireless network WN. The wireless network WN can be a network that complies with various wireless communication standards, such as a WiFi network. After receiving the error information EI, the remote electronic device RD correspondingly controls the target electronic device TD to perform a debug procedure corresponding to the error information EI through the transceiving device 105.

In one embodiment, the target electronic device TD comprises a wireless communication device 107, and the error detecting device 101, the debug device 103, and the transceiving device 105 are all provided in the wireless communication device 107. The wireless communication device 107 is a device that can provide a wireless communication function to the target electronic device TD, such as a wireless network card. The wireless network card can be a network card following various wireless communication standards, for example, it can be a WiFi wireless network card. In such embodiment, the error detecting device 101 can automatically and periodically detect errors and transmit corresponding error information EI to the remote device RD, so as to ensure that the target electronic device TD can always maintain normal operation. Alternatively, the error detecting device 101 can receive a debug command input by the user and then automatically detect the error and transmit the corresponding error information EI to the remote device RD for debug.

The errors detected by the error detecting device 101 can be various types of errors. In one embodiment, the wireless communication device 107 is connected to the target electronic device TD through a connection interface. The connection interface can be various types of connection interfaces. For example, the connection interface can be a PCIe (Peripheral Component Interconnect Express) interface. In such example, the error detecting device 101 can detect whether the connection interface has an error. For example, the error detecting device 101 can detect whether the connection interface can transmit data or receive data correctly, so as to generate corresponding error information EI.

In one embodiment, the target electronic device TD comprises at least one communication interface, and the error detecting device 101 detects whether the communication interface has an error or not. For example, the target electronic device TD comprises a bus, so that the devices therein can exchange data with each other, and the error detecting device 101 detects whether the bus has an error or not. For example, the error detecting device 101 detects whether a first device in the target electronic device TD receives a corresponding response after transmitting a request to a second device through the bus. For another example, the error detecting device 101 detects whether the first device in the target electronic device TD receives corresponding data after transmitting a request to a second device through the bus and receiving a corresponding response from the second device.

In another embodiment, the target electronic device TD comprises at least one communication interface, and the error detecting device 101 detects if a first communication connection between the communication interfaces has an error or detects if a second communication between the communication interface and the external communication interface has an error. For example, the target electronic device comprises a USB interface and an internal bus, and the error detecting device 101 detects whether the data error rate between the USB interface and the internal bus meets a required level to determine whether there is an error. For another example, the target electronic device comprises a USB interface, and the USB interface is electrically coupled to a USB interface in an external electronic device. The error detecting device 101 detects whether the data error rate between the two USB interfaces meets a required level to determine whether there is an error.

In yet another embodiment, the error detecting device 101 detects whether a state machine of the target electronic device TD has an error. The state machine represents the state of each device in the target electronic device TD or the state of the target electronic device TD itself, such as an active state, a standby state, a transmitting state or a receiving state. The error detecting device 101 can detect whether the state of the state machine is transitioned as expected, or whether the state machine is in an expected state, so as to determine whether there is an error.

As mentioned above, after receiving the error information EI, the remote electronic device RD correspondingly controls the target electronic device TD to perform a debug procedure corresponding to the error information EI through the transceiving device 105. The debug procedure may have different steps corresponding to different designs or different requirements. In one embodiment, the debug procedure comprises controlling the target electronic device TD to transmit specific data to the remote electronic device RD. For example, the remote electronic device RD can control the target electronic device TD to transmit data temporarily stored in a specific register, or to transmit data at a specific address in the storage device of the target electronic device TD for further error determination and removal. In another embodiment, the debug procedure comprises controlling the target electronic device TD to perform a reset operation. For example, the target electronic device TD can transmit a control command CMD to the debug device 103 through the transceiving device 105, so that the debug device 103 resets the target electronic device TD. Such reset operation can reset at least one device in the target electronic device TD or reset the entire target electronic device TD (for example, reboot).

However, please note that after the debug device 103 receives the error information EI transmitted by the error detecting device 101, it is not limited to transmit the error information EI to the remote electronic device RD. In one embodiment, after receiving the error information EI transmitted by the error detecting device 101, the debug device 103 can selectively transmit the error information EI to the remote electronic device RD, or automatically reset a device which is in the target electronic device TD and has an error, or automatically reset the target electronic device TD. In addition, in one embodiment, the error detecting device 101 can be integrated into the debug device 103. In other words, the aforementioned operation of detecting errors can be performed by the debug device 103.

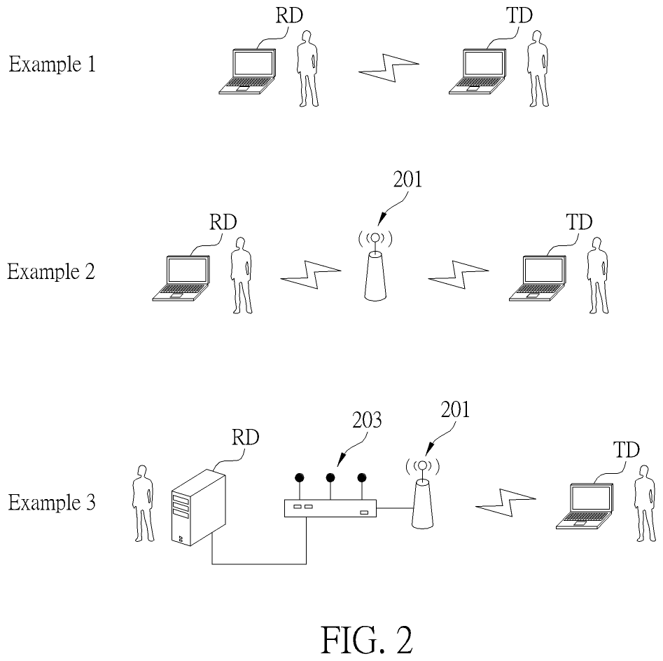

The aforementioned target electronic device TD can communicate with the remote electronic device RD in various ways. FIG. 2 is a schematic diagram illustrating that a target electronic device TD communicates with a remote electronic device RD, according to different embodiments of the present invention. In Example 1 and Example 2, both the target electronic device TD and the remote electronic device RD are laptop computer computers. However, in Example 3, the target electronic device TD is a laptop computer and the remote electronic device RD is a desktop computer.

As shown in Example 1 of FIG. 2, the target electronic device TD directly communicates with the remote electronic device RD in a wireless manner, such as wirelessly connecting through the aforementioned wireless network card 107. In the Example 2 in FIG. 2, the target electronic device TD and the remote electronic device RD are respectively connected to the same wireless base station 201 through wireless communication. However, the target electronic device TD and the remote electronic device RD can be respectively wirelessly connected to different wireless base stations, and then these wireless base stations are connected to the network, so that the target electronic device TD and the remote electronic device RD can communicate with each other. In the Example 3 of FIG. 2, the target electronic device TD is connected to the wireless base station 201 in a wireless manner, and the remote electronic device RD is connected to the wireless base station 201 through the Ethernet switch 203, so that the target electronic device TD can communicate with the remote electronic device RD. However, the target electronic device TD and the remote electronic device RD can also be connected to different wireless base stations through the structure of Example 3, and then these wireless base stations are connected to the network, so that the target electronic device TD and the remote electronic device RD can communicate with each other.

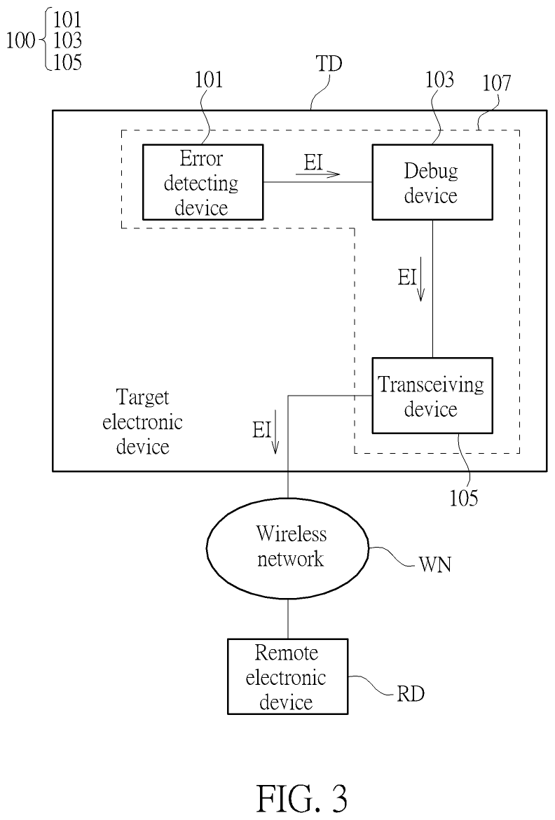

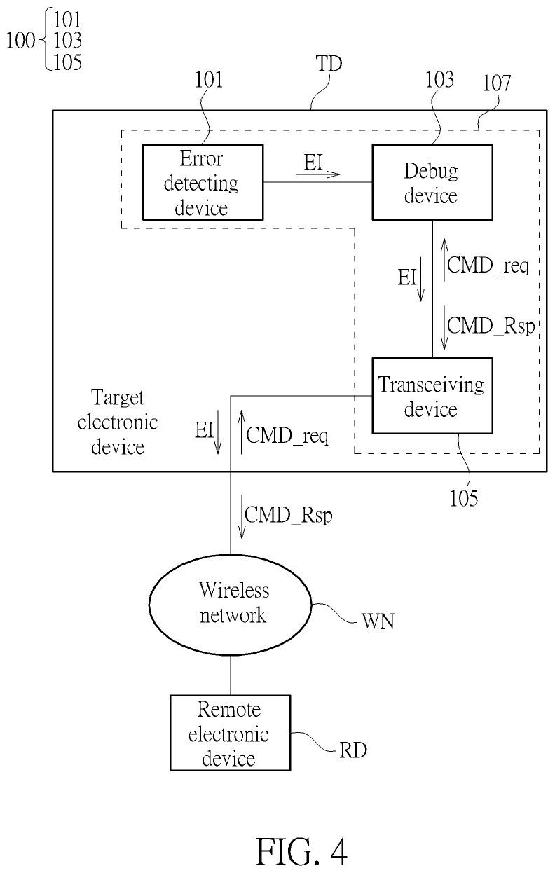

FIG. 3 and FIG. 4 are schematic diagrams illustrating that the electronic debug system operates in different modes, according to different embodiments of the present invention. However, please note that the operations in FIG. 3 and FIG. 4 are just examples. The operation of the electronic device debug system provided by the present invention is not limited to the operations shown in FIG. 3 and FIG. 4. In the embodiment shown in FIG. 3, the electronic device debug system 100 is operating in a user mode. For example, the target electronic device TD has been manufactured and sent to the user, and the user is using the target electronic device TD normally. In the user mode, if the error detecting device 101 detects an error, it transmits the corresponding error information EI to the debug device 103, the debug device 103 automatically reset the target electronic device TD, and transmits the error information EI to the remote device RD through the transceiving device 105. In addition to the error information EI, the error detecting device 101 can also transmit device parameters related to the error information of the target electronic device TD to the remote electronic device RD. In the user mode, the remote device RD only collects error information EI or related device parameters, but does not perform the debug procedure.

In the embodiment shown in FIG. 4, the electronic device debug system 100 is operating in the debug mode. For example, the target electronic device TD has been manufactured but has not been sent to the user, and is still tested by the manufacturer or the tester. However, the debug mode can also be used when the target electronic device TD has been manufactured and delivered to the user. In the debug mode, if the error detecting device 101 detects an error, it transmits the corresponding error information EI to the debug device 103, and the debug device 103 will transmit the error information EI to the debug device 103 through the transceiving device 105. The debug device 103 does not reset automatically. In addition to the error information EI, the error detecting device 101 can also transmit device parameters related to the error information of the target electronic device TD to the remote device RD. Then, the remote device RD generates a debug request command CMD_req to the debug device 103 to perform a debug procedure, so that the target electronic device TD correspondingly transmits specific data or resets. In one embodiment, after receiving the debug request command CMD_req, the debug device 103 will reply a response command CMD_rsp to the remote device RD and perform corresponding debug operations.

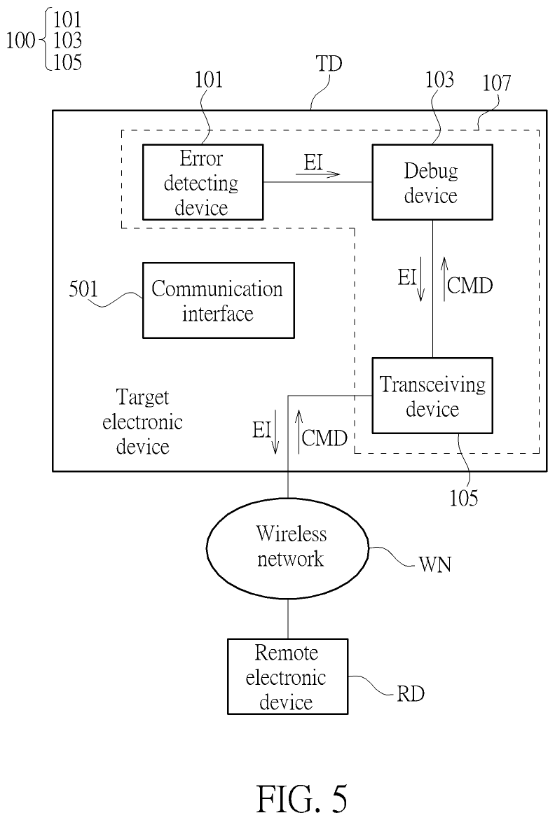

In addition to the debug mechanisms described in the above-mentioned embodiments, the electronic device debug system provided by the present invention may have other debug mechanisms. FIG. 5 is a block diagram illustrating an electronic debug system according to another embodiment of the present invention. As shown in FIG. 5, the electronic device debug system 100 further comprises a communication interface 501 (such as a USB interface). The target electronic device TD can be physically connected to an analysis device through the communication interface 501, and the analysis device can also perform the debug procedure to the target electronic device TD. In other words, the electronic device debug system 100 can be used for debugging by conventional electronic device debug methods. In one embodiment, the error detecting device 101 periodically performs error detection to the communication interface 501. If the communication interface 501 operates normally, the error detecting device 101 does not transmit the error information EI to the remote electronic device RD according to the steps of the foregoing embodiments. If the communication interface 501 has an error and cannot operate normally, the error detecting device 101 transmits the error information EI to the remote device RD through the steps of the above-mentioned embodiments.

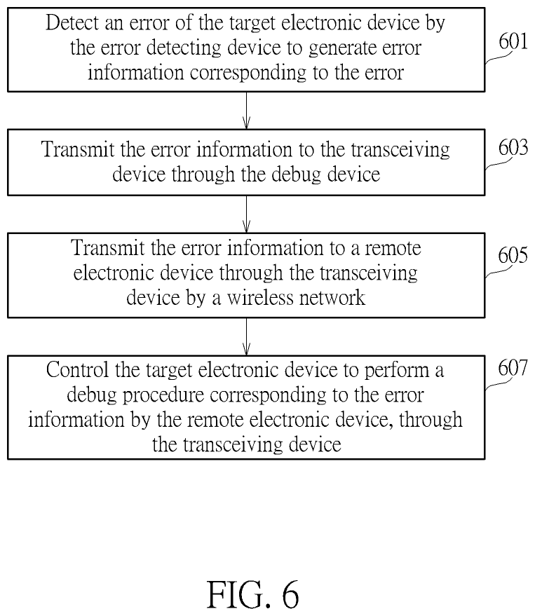

According to the above-mentioned embodiments, an electronic device debug method can be obtained. FIG. 6 is a flow chart illustrating an electronic device debug method according to one embodiment of the present invention, which is used in a target electronic device comprising an error detecting device, a debug device, and a transceiving device (for example, the target electronic device TD in FIG. 1). The method comprises:

### Step 601

Detect an error of the target electronic device by the error detecting device to generate error information corresponding to the error (such as the error information EI in FIG. 1).

### Step 603

Transmit the error information to the transceiving device through the debug device.

### Step 605

Transmit the error information to a remote electronic device (such as the remote electronic device RD in FIG. 1) through the transceiving device by a wireless network (such as the wireless network WN in FIG. 1).

### Step 607

Control the target electronic device to perform a debug procedure corresponding to the error information by the remote electronic device, through the transceiving device.

Other detail steps have been described in the foregoing embodiments, thus descriptions thereof are omitted for brevity here.

In view of above-mentioned embodiments, even if the target electronic device has an error but cannot debug by itself, and the communication interface providing a wired connection is damaged, the error information can still be provided to other electronic devices in a wireless connection to debug the target electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device debug method, applied to a target electronic device with an error detecting device, a debug device, and a transceiving device, comprising:
(a) detecting an error of the target electronic device by the error detecting device to generate error information corresponding to the error;
(b) transmitting the error information to the transceiving device through the debug device;
(c) transmitting the error information to a remote electronic device through the transceiving device by a wireless network; and
(d) controlling the target electronic device to perform a debug procedure corresponding to the error information by the remote electronic device, through the transceiving device.

2. The electronic device debug method of claim 1, the target electronic device comprising a wireless communication device, the error detecting device, the debug device, and the transceiving device being provided in the wireless communication device.

3. The electronic device debug method of claim 1, the target electronic device comprising at least one communication device, and the step (a) detecting if the communication interface has the error.

4. The electronic device debug method of claim 1, the step (a) detecting whether a state machine of the target electronic device has the error or not.

5. The electronic device debug method of claim 1, the target electronic device comprising at least one communication interface, the step (a) detecting if a first communication connection between the communication interface has the error or not, or detecting if a second communication connection between the communication interface and an outer communication interface has the error or not.

6. The electronic device debug method of claim 1, the target electronic device comprising a wireless communication device electrically coupled to the target electronic device through a connection interface, the step (a) detecting if the connection interface has the error or not.

7. The electronic device debug method of claim 1, the debug procedure comprising: controlling the target electronic device to transmit specific data to the remote electronic device.

8. The electronic device debug method of claim 1, the debug procedure comprising: resetting the target electronic device.

9. The electronic device debug method of claim 1, the debug device selectively performing following operations after the error detecting device detects the error of the target electronic device:
transmitting the error information to the remote electronic device, automatically resetting a device with the error, and automatically resetting the target electronic device.

10. The electronic device debug method of claim 1, the error detecting device being integrated to the debug device.

11. An electronic debug system, comprising:
an error detecting device, configured to detect an error of a target electronic device to generate error information corresponding to the error;
a debug device, configured to receive the error information from the error detecting device; and
a transceiving device, configured to receive the error information from the debug device, and configured to transmit the error information to a remote electronic device by a wireless network;
the remote electronic device controlling the target electronic device to perform a debug procedure corresponding to the error information through the transceiving device.

12. The electronic debug system of claim 11, the target electronic device comprising a wireless communication device, the error detecting device, the debug device, and the transceiving device being provided in the wireless communication device.

13. The electronic debug system of claim 11, the target electronic device comprising at least one communication device, and the error detecting device detecting if the communication interface has the error.

14. The electronic debug system of claim 11, the error detecting device detecting whether a state machine of the target electronic device has the error or not.

15. The electronic debug system of claim 11, the target electronic device comprising at least one communication interface, the error detecting device detecting if a first communication connection between the communication interface has the error or not, or detecting if a second communication connection between the communication interface and an outer communication interface has the error or not.

16. The electronic debug system of claim 11, the target electronic device comprising a wireless communication device electrically coupled to the target electronic device through a connection interface, the error detecting device detecting if the connection interface has the error or not.

17. The electronic debug system of claim 11, the debug procedure comprising: controlling the target electronic device to transmit specific data to the remote electronic device.

18. The electronic debug system of claim 11, the debug procedure comprising: resetting the target electronic device.

19. The electronic debug system of claim 11, the debug device selectively performing following operations after the error detecting device detecting the error of the target electronic device:
transmitting the error information to the remote electronic device, automatically resetting a device with the error, and automatically resetting the target electronic device.

20. The electronic debug system of claim 11, the error detecting device being integrated to the debug device.
